(19) United States
(12) Patent Application Publication
(10) Pub. No.: US 2016/0275162 A1
(43) Pub. Date: Sep. 22, 2016

(54) METHOD AND APPARATUS FOR PARTITIONING OR COMBINING MASSIVE DATA

(71) Applicant: ELECTRONICS AND TELECOMMUNICATIONS RESEARCH INSTITUTE, Daejeon (KR)

(72) Inventor: Seung Hyub JEON, Anyang-si (KR)

(21) Appl. No.: 15/070,533

(22) Filed: Mar. 15, 2016

(30) Foreign Application Priority Data
Mar. 20, 2015 (KR) 10-2015-0039050

(51) Int. Cl. G06F 17/30

(52) U.S. Cl. CPC G06F 17/30584; G06F 17/30289

(57) ABSTRACT

A method and an apparatus for partitioning or combining massive data, which can efficiently partition and combine data when an operation is executed by being distributed to a plurality of nodes in an environment such as genome analysis, in which massive data can be partitioned and executed. The method includes storing meta information on partition or combination of at least one data, if a request for data is sensed, acquiring meta information corresponding to the data, partitioning or combining the data, based on the meta information, and transmitting the partitioned or combined data in response to the request.

### CROSS-REFERENCE TO RELATED APPLICATION

This application claims priority to and the benefit of Korean Patent Application No. 10-2015-0039050, filed on Mar. 20, 2015, in the Korean Intellectual Property Office, the entire contents of which are incorporated herein by reference in their entirety.

### BACKGROUND

1. Field

An aspect of the present disclosure relates to a method and an apparatus for partitioning or combining massive data, and more particularly, to a method and an apparatus for partitioning or combining massive data, which can efficiently partition and combine data when an operation is executed by being distributed to a plurality of nodes in an environment such as genome analysis, in which massive data can be partitioned and executed.

2. Description of the Related Art

As a high-speed coprocessor such as general-purpose computing on graphics processing units (GPGPU) or Many Integrated Core (MIC) appears, studies on a method for increasing a throughput by simultaneously utilizing a CPU including a plurality of nodes and a plurality of coprocessors in an environment, such as a cluster, including a plurality of nodes have recently been conducted.

In order to efficiently increase a throughput in the above-described environment, an application program should correct itself. However, it is difficult to substantially correct the program in the current programming environment.

For the above-described reason, a method of utilizing the existing application program rather than a new application program, partitioning data to be processed with a specific size to be executed through coprocessors, and combining the processed results is used in fields such as genome analysis. In this case, if the size of data is very large, cost required to process input/output overheads occurring in partition/combination of the data may be greater than that required to employ high-speed coprocessors. In addition, if there is no medium that nodes can share with one another, such as a shared storage device, even when an operation on partitioned data is executed by being distributed to each of the nodes through an operation scheduler such as simple Linux utility for resource management (SLURM), the operation is distributed to all of the nodes. In this state, although other nodes have extra resources, the operation is concentration on specific nodes, and therefore, data processing may be delayed.

### SUMMARY

Embodiments provide a method and an apparatus for partitioning or combining massive data, which can partition data and utilize parallel resources while minimizing cost required in partition/combination of data in an environment which employs high-speed coprocessors for processing data, such as general-purpose computing on graphics processing units (GPGPU) or Many Integrated Core (MIC), or includes a plurality of clusters.

Embodiments also provide a method and an apparatus for partitioning or combining massive data, which can generate a virtual data container for providing remote data as if it is local data, so that an operation could be conventionally executed only after data was downloaded can be processed in real time such as data streaming.

According to an aspect of the present disclosure, there is provided a method for partitioning or combining massive data, the method including: storing meta information on partition or combination of at least one data; if a request for data is sensed, acquiring meta information corresponding to the data; partitioning or combining the data based on the meta information; and transmitting the partitioned or combined data in response to the request.

According to an aspect of the present disclosure, there is provided an apparatus for partitioning or combining massive data, the apparatus including: a meta repository configured to store meta information on partition or combination of at least one data; a meta processor configured to, if a request for data is sensed, acquire meta information corresponding to the data and partition or combine the data, based on the meta information; and a protocol processor configured to transmit the partitioned or combined data in response to the request.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a general method for partitioning or combining data.

FIG. 2 is a diagram illustrating a method for partitioning or combining data according to the present disclosure.

FIG. 3 is a diagram illustrating meta information according to the present disclosure.

FIG. 4 is a diagram illustrating an embodiment of meta information on partitioned data according to the present disclosure.

FIG. 5 is a diagram illustrating an embodiment of meta information on combined data according to the present disclosure.

FIG. 6 is a block diagram illustrating a structure of an apparatus for partitioning or combining data according to the present disclosure.

FIG. 7 is a diagram illustrating an operation of a protocol processor in a network.

FIG. 8 is a sequence diagram illustrating the method for partitioning or combining data according to the present disclosure.

FIG. 9 is a flowchart illustrating the method for partitioning or combining data according to the present disclosure.

### DETAILED DESCRIPTION

The present disclosure now will be described more fully hereinafter with reference to the accompanying drawings, in which embodiments of the present disclosure are shown. The present disclosure should not be construed as limited to the embodiments set forth herein. Rather, these embodiments are provided so that this disclosure will be thorough and complete, and will fully convey the scope of the present disclosure to those skilled in the art.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

As used herein, the singular forms are intended to include the plural forms as well, unless the context clearly indicates otherwise.

Hereinafter, exemplary embodiments of the present disclosure will be described in detail with reference to the accompanying drawings.

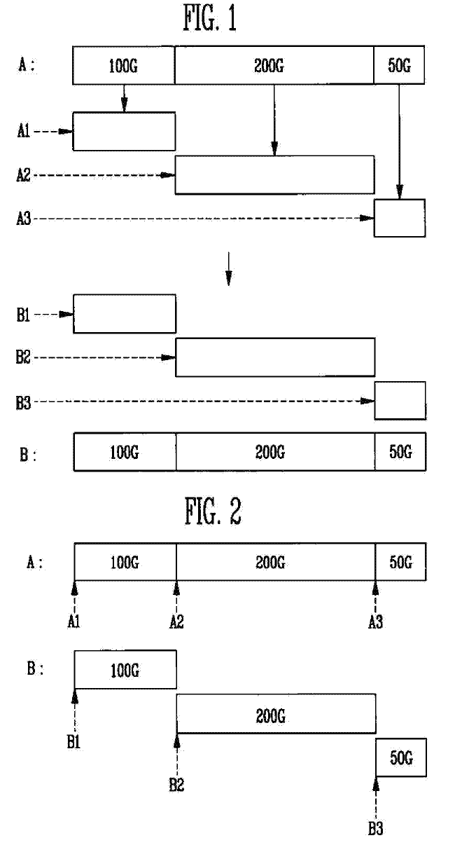

FIG. 1 is a diagram illustrating a general method for partitioning or combining data.

Referring to FIG. 1, in the general method, data A is partitioned and copied into three data A1, A2, and A3 for respective nodes, and the nodes process the copied data A1, A2, and A3, respectively. After that, the nodes generate data B1, B2, and B3 by processing the partitioned data A1, A2, and A3, respectively. The generated data B1, B2, and B3 are combined and copied into combined data B. Finally, the data A is processed as the data B through the three nodes.

In the above-described method, a first disk input/output is generated in the process of copying the data A into the partitioned data A1, A2, and A3, and a second disk input/output is generated in the process of copying the data B1, B2, and B3 into the combined data B. As the size of data increases, processing cost required to perform a disk input/output increases.

In order to reduce the processing cost required to perform the disk input/output, there may be considered a method for processing data without copying an actual data block, such as a symbolic link of Linux. However, the symbolic link can be applied to only the entire data, and is not applied to partial data as shown in the above-described embodiment. In addition, there may be considered a method for partitioning and processing data without copying partitioned data. However, the method is applicable in an environment using a single node, and has a problem in that actual data and an actual file system should be modified. If the data A is stored on a commercial file system, the modification of the data itself is impossible, and therefore, a method for partitioning and processing data itself may be applied.

Hereinafter, a method for partitioning or combining data using pointing information to minimize the disk input/output generated in partition/combination of the data without changing the actual data will be described.

The present disclosure described below can be applied to embodiments in which original data existing in a network is partitioned or in which a plurality of original data are partitioned. In the following description, the partition of data means that original data existing in a network is partitioned into data A1, A2, . . . , An. Also, the combination of data means that original data B1, B2, . . . , Bn existing in a network are combined into data B. In various embodiments, when a result obtained by processing original data A is data B, the data B may be called as original data. However, in the following embodiments, data stored in an original format in a network to have a separate reference position is referred to as original data, for convenience of illustration. In the following embodiments, data A1, A2, . . . , An that have the same reference position but have different offsets (load start points) and/or sizes are referred to as partitioned data with respect to original data A existing at the corresponding reference position, and data formed by combining a plurality of original data B1, B2, . . . , Bn existing at different reference positions is referred to as combined data B.

Hereinafter, the present disclosure will be described in detail according to the above-described details.

FIG. 2 is a diagram illustrating a method for partitioning or combining data according to the present disclosure.

The method according to the present disclosure enables data to be partitioned or combined in a streaming format using meta information on data. That is, in the present disclosure, an apparatus for partitioning or combining data stores only meta information on partition or combination of original data without copying or correcting the original data in the middle of the partition or combination, and, when specific data is requested, substantially loads partitioned or combined data using meta information on the requested data.

According to the above-described method, original data existing in a network may exist as virtual data on meta information before the original data is substantially loaded. The virtual data enables a user to recognize as if the original data is data existing in a user device even when the user does not substantially downloads the original data from the network.

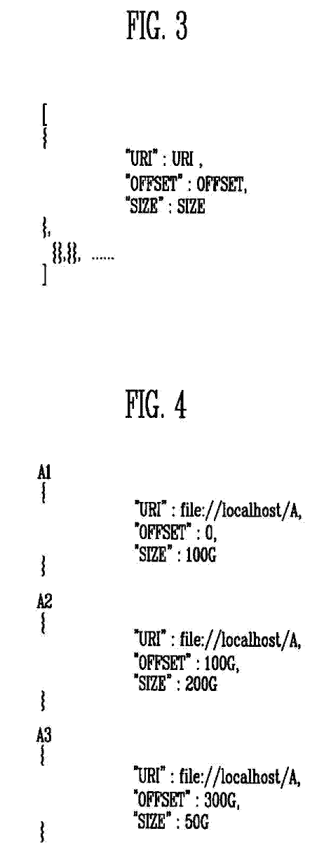

In various embodiments of the present disclosure, the meta information, as shown in FIG. 3, may be formed in a format such as XML or JSON.

The meta information may include information on a position of original data to which partitioned or combined data refers. The position of the original data may represent a protocol, a server location, a file name, etc. As shown in FIG. 3, the position of the original data may be designated by URI, but the present disclosure is not limited thereto. When original data A is partitioned into a plurality of data A1, A2, and A3, meta information of the plurality of partitioned data A1, A2, and A3 may equally include information on a position of the original data A. Meanwhile, when data B is formed by combining a plurality of original data B1, B2, and B3, meta information of the data B may include information on a position of each of the plurality of original data B1, B2, and B3.

The meta information may include information on an offset (a load start point) of partitioned or combined data in original data. In the case of partitioned data, the offset may correspond to a beginning or middle point of original data. In the case of combined data the offset includes an offset of each of a plurality of original data constituting the combined data. In this case, the offset may correspond to a beginning point of the original data. The offset may have a pointer format in which a specific position in the original data is indicated using a capacity, a data block, a data cluster, etc. As shown in FIG. 3, the offset may be designated by OFFSET, but the present disclosure is not limited thereto. In FIG. 3, there is illustrated a case where the offset is represented as a point at which a specific capacity is passed from the beginning point of the original data. In various embodiments, the offset may be called as a partition point, etc.

The meta information may include information on a size of partitioned or combined data. In the case of partitioned data A1, A2, and A3, the size of each of the partitioned data A1, A2, and A3 is smaller than the size of original data A, and the total size of the partitioned data A1, A2, and A3 is equal to the size of the original data A. In the case of combined data B, information on the size of the combined data B includes information on the size of each of a plurality of original data B1, B2, and B3, and the size of the combined data B is equal to the total size of the plurality of original data B1, B2, and B3. As shown in FIG. 3, the size may be designated by SIZE, but the present disclosure is not limited thereto.

Hereinafter, an embodiment of the method according to the present disclosure will be described in detail.

Referring to FIG. 2, when data A is partitioned into a plurality of partitioned data A1, A2, and A3, the apparatus may store meta information on partition of the data A. In this case, the meta information may include information representing positions of the original data A with respect to the respective partitioned data A1, A2, and A3, information representing offsets of the plurality of partitioned data A1, A2, and A3 in the original data A, and information representing sizes of the plurality of partitioned data A1, A2, and A3.

The meta information, as shown in FIG. 4, may include information on the positions of the original data A, the offsets, and the sizes with respect to the respective partitioned data A1, A2, and A3. A2 will be described as an example. The URI of an original position of A2 is file://localhost/A, and A2 refers to the original data A (i.e., A2 is partitioned data of the data A). A2 has a size of 200G from a point at which 100G is passed from the beginning point of the original data A.

Meanwhile, referring to FIG. 2, when a plurality of data B1, B2, and B3 are combined into a combined data B, the apparatus may store meta information on combination of the plurality of data B1, B2, and B3. In this case, the meta information may include information representing positions of original data B1, B2, and B3 with the respective data B1, B2, and B3, information representing offsets of the plurality of data B1, B2, and B3, and information representing sizes of the plurality of data B1, B2, and B3.

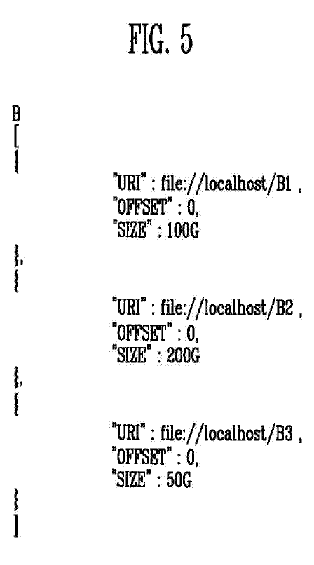

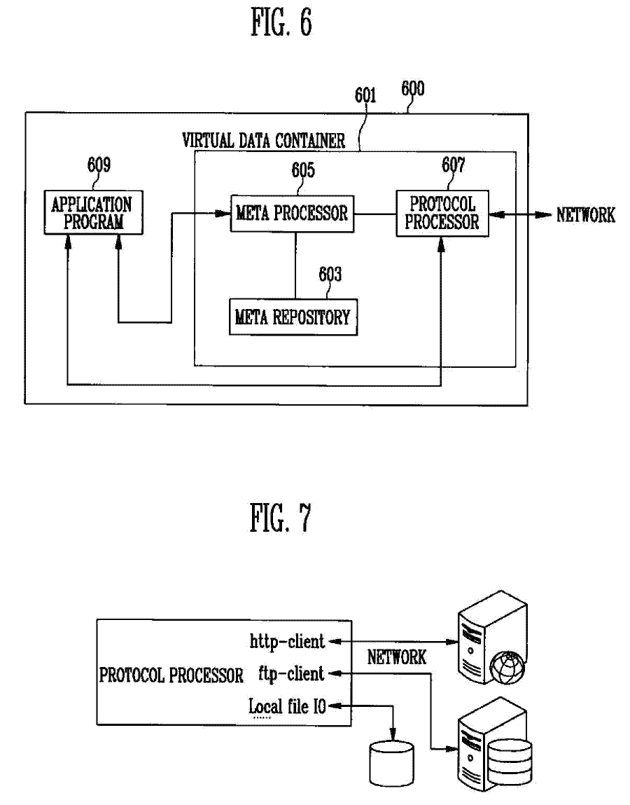

The meta information, as shown in FIG. 5, may include information on the positions of the original data, the offsets, and the sizes with respect to the respective data B1, B2, and B3. B2 will be described as an example. The URI of an original position of B2 is file://localhost/B2, and B2 refers to local data B2 (i.e., B2 refers to the original data itself). B2 has a size of 200G from the beginning point of the original data B2. The combined data B formed by combining the plurality of data B1, B2, and B3 has a size of 350G that is a sum of the sizes of the data B1, B2, and B3.

In various embodiments of the present disclosure, the apparatus stores the above-described meta information. Also, when a request of specific data is sensed, the apparatus acquires meta information corresponding to the corresponding data and transmits data partitioned or combined based on the meta information in response to the request.

FIG. 6 is a block diagram illustrating a structure of an apparatus for partitioning or combining data according to the present disclosure.

Referring to FIG. 6, the apparatus 600 according to the present disclosure includes a virtual data container 601. The virtual data container 601 stores, as meta information, information on partition or combination of original data existing in a network, and manages the stored information as virtual data. The virtual data container 601 performs an operation of loading the original data only when the load of specific data is requested.

The virtual data container 601 includes a meta repository 603, a meta processor 605, and a protocol processor 607.

The meta repository 603 stores meta information on partition or combination of at least one data. The meta information is the same as described with reference to FIGS. 2 to 5. The meta information may be managed as a file or database having an arbitrary format.

When a request for data is sensed from an application program 609, the meta processor 605 performs a function of mapping the requested data to the original data existing in the network. The meta processor 605 acquires meta information corresponding to the requested data from the meta repository 603, and identifies a position of the original data, an offset, and a size with respect to the requested data, based on the meta information. The meta processor 605 controls the protocol processor 607 to load actual data in the network, based on the identified meta information.

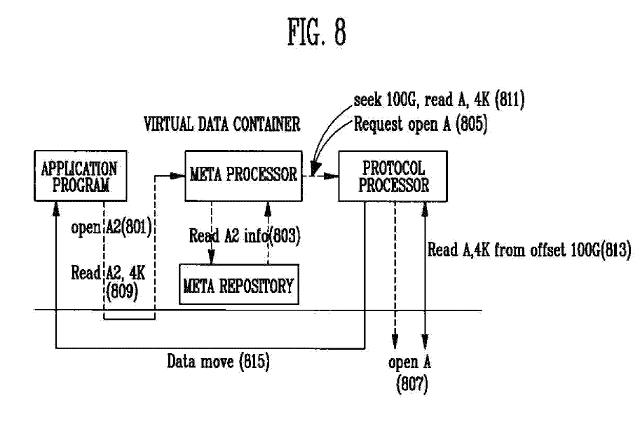

The protocol processor 607 actually loads data by parsing the URI of the data requested by the meta processor 605. The protocol processor 607, as shown in FIG. 7, may load not only local data but also data from a plurality of nodes. The protocol processor 607 may include a client of the existing protocol (http, ftp, file, etc.). The protocol processor 607 receives an actual data block from the network through the client of the protocol according to a service provided at a remote place, and transmits the received data block to the application program 609. The protocol processor 607 allows a user to recognize as if original data exists in a local place, and enables the user to access the original data.

FIG. 8 is a sequence diagram illustrating the method for partitioning or combining data according to the present disclosure.

Referring to FIG. 8, when a request for opening A2 is received from the application program (801), the meta processor acquires meta data on A2 from the meta repository (803). The meta processor acquires information on a position of original data A with respect to A2 from the acquired meta data, and requests the protocol processor to open the original data A (805). The protocol processor opens the requested original data A in the network (807).

After that, if a request for reading a size (4 Kbyte) of A2 is received from the application program (809), the meta processor acquires information on an offset and a size of A2 from the meta data, and requests the protocol processor to load partitioned data having the size of 4 Kbyte from a point at which 100G is passed from the beginning point of the original data A (811). The protocol processor loads partitioned data having the size of 4 Kbyte from the point at which 100G is passed from the beginning point of the original data A (813), and transmits the loaded data to the application program (815).

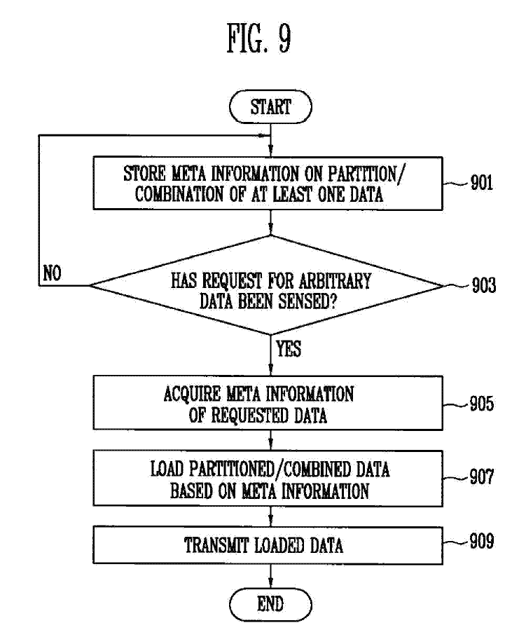

FIG. 9 is a flowchart illustrating the method for partitioning or combining data according to the present disclosure.

Referring to FIG. 9, the apparatus according to the present disclosure stores meta information on partition or combination of at least one data (901). Detailed description of the meta information is the same as described with reference to FIGS. 2 to 5.

If a request for data is sensed (903), the apparatus acquires meta information corresponding to the requested data (905). The meta information may include at least one of at least one position of original data with respect to the data, an offset of the data in the original data, and a size of the data. Specifically, when the meta information is meta information on partition of data the meta information may include at least one of positions of original data with respect to a plurality of partitioned data, offsets of the plurality of partitioned data in the original data, and sizes of the plurality of partitioned data. When the meta information is meta information on combination of data, the meta information may include at least one of positions of original data with respect to a plurality of data constituting combined data and sizes of the plurality of data.

After that, the apparatus loads partitioned or combined data, based on the meta information (907). Specifically, the apparatus opens original data of the data, based on the information on the position of the original data corresponding to the data, and loads the data by its size from the start point in the original data, based on the information on the start point corresponding to the data and the size of the data. Alternatively, the apparatus opens a plurality of original data, based on information on positions of the plurality of data corresponding to the data, and loads and combines the plurality of original data, based on information on the start point corresponding to the data and the size of the data.

The apparatus transmits the partitioned or combined data in response to the request (909).

In the method and apparatus according to the present disclosure, the time required in partition/combination of data is reduced, so that it is possible to maximize advantages when a plurality of nodes or high-speed coprocessors and to increase a throughput.

Also, the time until data of a remote node is copied into local data is not required, and data can be immediately processed through data streaming.

Also, in an environment of clusters each having a local storage, an operation can be performed while flexibly changing a node at the operation is to be performed without fixing the node.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method for partitioning or combining massive data, the method comprising:
storing meta information on partition or combination of at least one data;
if a request for data is sensed, acquiring meta information corresponding to the data;
partitioning or combining the data, based on the meta information; and
transmitting the partitioned or combined data in response to the request.

2. The method of claim 1, wherein the meta information includes at least one of a position of original data with respect to the at least one data, an offset of the data in the original data, and a size of the data.

3. The method of claim 2, wherein the transmitting of the partitioned or combined data in response to the request includes:
opening the original data of the data, based on information on the position of the original data corresponding to the data;
loading partitioned data by the size of the data from the offset in the original data, based on the offset corresponding to the data and the size of the data; and
transmitting the loaded partitioned data.

4. The method of claim 2, wherein the transmitting of the partitioned or combined data in response to the request includes:
opening a plurality of original data corresponding to the data, based on information on positions of the plurality of original data;
loading and combining the plurality of original data, based on the offset corresponding to the data and the size of the data; and
transmitting the loaded and combined data.

5. The method of claim 1, wherein, when the meta information is meta information on partition of data, the meta information includes at least one of positions of original data with respect to a plurality of partitioned data, offsets of the plurality of partitioned data, and sizes of the plurality of partitioned data.

6. The method of claim 1, wherein, when the meta information is meta information on combination of data, the meta information includes at least one of information on positions of original data with respect to a plurality of data constituting combined data and information on sizes of the plurality of data.

7. An apparatus for partitioning or combining massive data, the apparatus comprising:
a meta repository configured to store meta information on partition or combination of at least one data;
a meta processor configured to, if a request for data is sensed, acquire meta information corresponding to the data and partition or combine the data, based on the meta information; and
a protocol processor configured to transmit the partitioned or combined data in response to the request.

8. The apparatus of claim 7, wherein the meta information includes at least one of a position of original data with respect to the at least one data, an offset of the data in the original data and a size of the data.

9. The apparatus of claim 8, wherein the meta processor controls the protocol processor to open the original data of the data, based on information on the position of the original data corresponding to the data, load partitioned data by the size of the data from the offset in the original data, based on the offset corresponding to the data and the size of the data, and transmit the loaded partitioned data.

10. The apparatus of claim 8, wherein the meta processor controls the protocol processor to open a plurality of original data corresponding to the data, based on information on positions of the plurality of original data, load and combine the plurality of original data, based on the offset corresponding to the data and the size of the data, and transmit the loaded and combined data.

11. The apparatus of claim 7, wherein, when the meta information is meta information on partition of data, the meta information includes at least one of positions of original data with respect to a plurality of partitioned data, offsets of the plurality of partitioned data, and sizes of the plurality of partitioned data.

12. The apparatus of claim 7, wherein, when the meta information is meta information on combination of data, the meta information includes at least one of information on positions of original data with respect to a plurality of data constituting combined data and information on sizes of the plurality of data.
